(19) United States
(12) Patent Application Publication
(10) Pub. No.: US 2022/0071221 A1
(43) Pub. Date: Mar. 10, 2022

(54) SYSTEM AND METHODS FOR TREATING MEAT

(71) Applicant: LONG LIFE MEAT COMPANY LIMITED, Invercargill (NZ)

(72) Inventor: ASHLEY JUKES, OTAUTAU (NZ)

(73) Assignee: LONG LIFE MEAT COMPANY LIMITED, Invercargill (NZ)

(21) Appl. No.: 17/468,657

(22) Filed: Sep. 7, 2021

(30) Foreign Application Priority Data
Sep. 4, 2020 (NZ) NZ 767706

(51) Int. Cl. A23B 4/027; A23L 3/015; A23B 4/06; B65B 61/20; B65B 31/04

(52) U.S. Cl. CPC A23B 4/027; A23L 3/0155; B65B 31/04; B65B 61/20; A23B 4/06

(57) ABSTRACT

Systems and methods of treating meat are provided. An example process extends the storage longevity of a meat, and the quality of the stored meat, by infusing an absorbent pad with a sodium chlorite solution, placing meat to be stored on the absorbent pad, sealing the meat and the absorbent pad in a vacuum-packing bag to produce vacuum-packed meat, and placing the vacuum-packed meat in a refrigeration unit at a temperature around −1.5 degrees Celsius. Example systems automate the example process with apparatus components. The concentration of the sodium chlorite solution vacuum-packed with the meat on an absorbent pad is formulated to greatly increase the refrigerated storage life of the meat, over conventional preservation, at a specific temperature range between −1.7 to 0.0 degrees Celsius, while maintaining freshness qualities of the meat in taste and smell, and color.

### RELATED APPLICATIONS

This nonprovisional patent application claims the benefit of priority to New Zealand Provisional Patent Application No. NZ 767706, filed Sep. 4, 2020, and included by reference herein, in its entirety.

### FIELD OF THE INVENTION

The subject matter relates to meat processing with respect to ovine/bovine, carpine, and cervine products.

### BACKGROUND

Acidified sodium chlorite is a chemical compound that generates chlorine dioxide, and is conventionally used for bleaching and stripping of textiles, pulp, and paper. The acidified sodium chlorite can be made by mixing sodium chlorite with a weak acid solution to produce the short-lived acidified sodium chlorite that also has decontaminating properties. Acidified sodium chlorite is used in disinfection processes in municipal water treatment plants, by liberating the chlorine dioxide.

The chlorine dioxide that can be generated from sodium chlorite is also sometimes used to disinfect the water used to wash fruits, vegetables, and poultry. Sodium chlorite is also used therapeutically in contact lens cleaning solutions, washes, and toothpastes.

Previous studies have observed that the chlorite ion can seemingly improve the survival of seafoods. Sodium chlorite is used as a processing agent for the treatment of meat. The New Zealand and Australian Food Standards 1.3.3 sets out limitations on the amount of sodium chlorite allowed in the commercialization of meat. At present, between 500-1200 ppm of chlorite can be added to meat.

Meat is packaged and transported to supermarkets and the meat items placed on sale. The meat starts deteriorating as soon as it is cut from the animal source. The degree of deterioration can be indicated in the coloring of the meat, and the beginning of odors from the product. It would be useful to be able to extend the useful shelf life of meat once it has been cut from an animal source.

### SUMMARY

Systems and methods of treating meat are provided. An example process extends the storage longevity of a meat, and the quality of the stored meat, by infusing an absorbent pad with a sodium chlorite solution, placing meat to be stored on the absorbent pad, sealing the meat and the absorbent pad in a vacuum-packing bag to produce vacuum-packed meat, and placing the vacuum-packed meat in a refrigeration unit at a temperature around −1.5 degrees Celsius. Example systems automate the example process with apparatus components. The concentration of the sodium chlorite solution vacuum-packed with the meat on an absorbent pad is formulated to greatly increase the refrigerated storage life of the meat, over conventional preservation, at a specific temperature range between −1.7 to 0.0 degrees Celsius, while maintaining freshness qualities of the meat in taste and smell, and color.

This summary is not intended to identify key or essential features of the claimed subject matter, nor is it intended to be used as an aid in limiting the scope of the claimed subject matter.

### BRIEF DESCRIPTION OF THE DRAWINGS

FIG. 1 is a bar chart diagram of aerobic plate counts (APCs) indicating presence, no presence, or amounts of bacteria on meat samples versus time (as days in storage), for meat cuts treated according to the example method.

FIG. 2 is a graph of the aerobic plate counts (APCs) of FIG. 1.

FIG. 3 is a diagram of total microbial count (log CFU/cm²) of treated meat cuts between days 117-273 of storage, after treatment according to the example method.

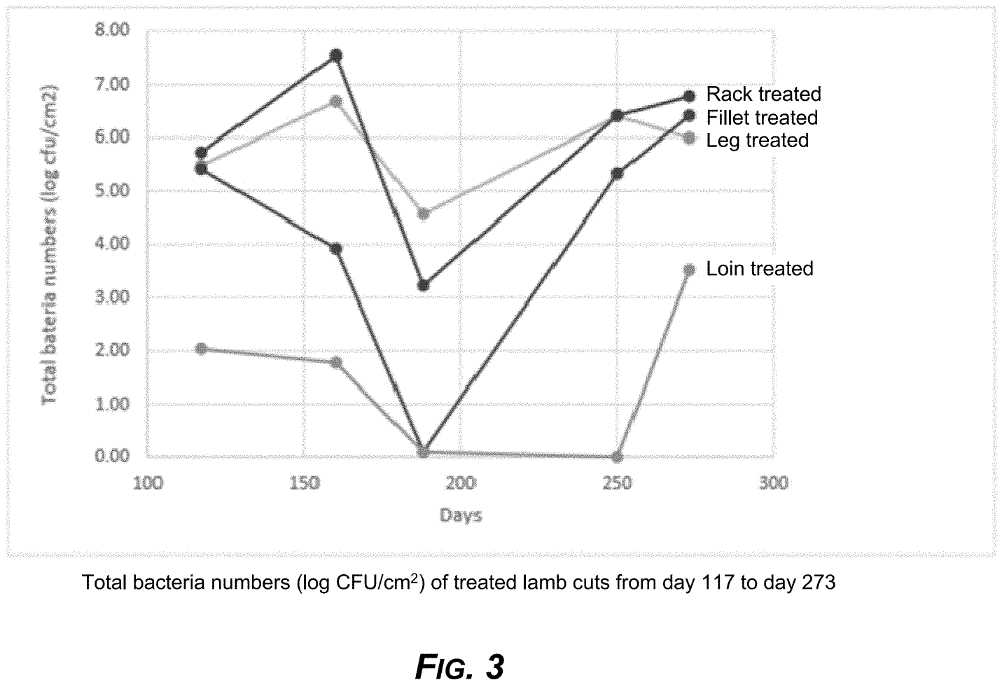

FIG. 4 is a flow diagram of an example method for increasing the storage life of a meat, while maintaining freshness qualities of the meat.

FIG. 5 is a block diagram of an example system for increasing the storage life of a meat, while maintaining freshness qualities of the meat.

### DETAILED DESCRIPTION

This disclosure describes a system and methods for treating meat. The meat is preferably ovine, bovine, carpine, or cervine. In this description, the term “ovine” comprises lamb, mutton, and hogget and encompasses any meat relating to “sheep” in a general meaning. In an example process, the longevity of stored fresh meat is prolonged by infusing a first side of an absorbent pad with sodium chlorite solution, placing the meat to be stored on a second side of the pad, placing the meat and pad in a vacuum bag, applying a vacuum, and refrigerating the vacuum-packed meat at a specified temperature range.

The term “pad” includes any cushioning means, squab, wad or the like on which meat can be placed prior to vacuum packaging. Preferably one side of the pad is absorbent, and the opposite side of the pad is non-absorbent. The meat to be treated is placed on the non-absorbent side.

Example absorbent pads useful in the example process are produced as Cryovac products, and are preferably used, but similar products can also be used (Sealed Air Corporation, Charlotte, N.C.).

The vacuum bag can be any barrier bag used for fresh meat produce, or other suitable container.

The refrigeration to be provided is preferably in a range of −1.7 to 0 degrees Celsius, for example, at a preferred value of approximately −1.5 degrees Celsius.

In an implementation, the concentration of chlorite added to the pad is less than about 100 ppm. A preferred range is a concentration of about 60-100 ppm, and a preferred value is about 72 ppm.

Within this specification, the term “pad” is intended to be interpreted widely and to comprise any small and/or soft material, or mass of anything soft, including a cushion, or support.

### Example Embodiments

An example formulation of chlorite solution uses 22 grams of chlorite powder and 78 g of water to make a stock solution.

Then 3.7 ml of this stock solution is added to 20 liters of purified water to make a preservative solution used in the product. This implementation of the preservative solution has a concentration of about 72 ppm.

In an example scenario, about 12-20 ml of the preservative solution is added to a Cryovac absorbent pad or other wrap (e.g., a 200/250 mm square pad), for example, about 16 ml can be preferably added.

### Experimental Results

### Experiment 1

Meat from a lamb was obtained on day one, and packed the next day in multiple bags according to the example process.

Two of the bags were opened on day 21, and maintained at a temperature of −1.0 degree C.

Another bag was opened on day 81. The meat still appeared freshly cut. There was no discoloration and there was no odor. The meat was tested after 90 days and found to be starting to deteriorate. At day 93 the meat was discarded as it was deteriorating. It was surmised that every degree of temperature over zero degrees Celsius could subtract five days from the shelf life of the meat.

### Experiment 2

Meat was treated with sodium chlorite solution and placed on Cryovac absorbent wrap and the meat was placed into a vacuum-packed bag and placed into a commercial refrigeration unit. In this instance the meat was lamb. The temperature of the commercial refrigerator was −1.5 degrees Celsius.

At day 63 the bag was opened and inspected by a testing panel of three qualified people. The meat appeared to be in good condition, and the quality as good as it had been on the day it was placed in the refrigeration unit. The meat tasted as good as it would have tasted if it had been eaten fresh.

Another bag of the same meat was opened on day 77. The testing panel of three people commented that the meat smelled good, had excellent color and was extremely tender and tasty to eat.

Another bag of the same meat was opened on day 90. The three testers commented that the meat looked as good as on the day it was placed in the refrigerator, and after tasting the meat, they commented that it has excellent color and flavor.

A fourth bag was opened on day 100, after being held in the refrigerator. The three testers determined that the meat was viable, with no odors, had excellent color for meat, and was extremely tender with an excellent flavor when eaten.

Conclusion: the meat in the trial subjected to the example process had been preserved well when stored in a refrigeration unit at the example temperature range, for up to 100 days. Even after 100 days, the meat tasted as good as it had prior to being placed in the refrigeration unit.

No further meat samples were available, so it was not possible to determine the longest time this same meat could have been held in the refrigeration unit without deteriorating.

### Experiment 3

A second trial used lamb and beef in a test. The meat was treated according to the example process and packed. An aerobic plate count by Petrifilm (3M Company, Maplewood, Minn.). On each of the following dates, one bag of the beef and one bag of the lamb was opened for testing:

At day 100, the qualified testers reported that the beef and the lamb was very tender, with no odor. A piece of the beef was placed in a household refrigerator for 14 more days, at the end of which the meat was still in a good condition.

At day 114, the testers determined that the meat had an appropriate appearance and freshness, and reported that the meat was very tender with no odors.

At day 129, a bag of the beef and a bag of the lamb was opened, and the testers determined that all the meat had an appropriate appearance and freshness, with no odors, and reported that the meat was very tender.

At day 142, a bag of the beef and a bag of the lamb was opened, and the testers determined that all the meat had an appropriate appearance and freshness, with no odors, and reported that the meat was very tender and had good color.

At this time, the pH levels of the beef and the lamb were tested: the pH of the beef was 5.55, and the pH of the lamb meat was 5.60.

At day 160, a bag of the beef and a bag of the lamb was opened. Aerobic plate counts (“APCs”) were zero on both the beef and lamb pieces of meat, indicating no bacteria or other microorganisms growing on the beef or the lamb meat. The testers determined that all the meat had an appropriate appearance and freshness, with no odors, and reported that the meat was very tender and had good color.

At day 180, a bag of the beef and a bag of the lamb were opened, and the testers determined that all the meat had an appropriate appearance, with no odors, and reported that the meat was very tender and had good color.

At day 202, a bag of the beef and a bag of the lamb were opened, and the testers determined that all the meat had an appropriate appearance, with no odors, and reported that the meat was very tender and had good color.

### Experiment 4

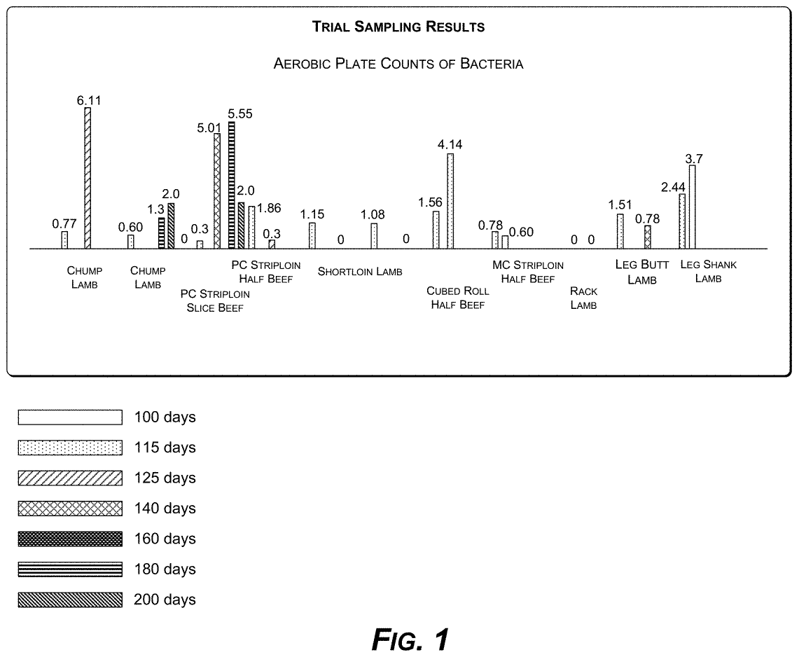

FIG. 1 shows aerobic plate counts (APCs) carried out at various times on meat samples treated and stored according to the example process. These tests provided indications of the level of bacteria in the stored samples. A bag or bags of the meat samples were opened and tested at the various time intervals shown in FIG. 1.

### Example Results

In FIG. 1, most of the results show an APC well below a required standard for fresh meat samples, which is “5.” There were three readings above this standard. In all three cases with a reading above 5, the results were compromised because the bags of meat to be tested had been opened and handled by meat workers prior to analysis. It was determined that the results of “6.11” were anomalous due to human contamination and not because of bacteria present in the samples prior to opening the bags. The results of “5.2” and “5.5” were also determined to be due to human contamination. None of the meat samples analyzed had odors or other degradation.

While the example process has been described to this point with reference to the meat samples above, numerous modifications and improvements may be made to the example process without departing from the scope of the subject matter as set forth in this specification. For example, the example process is intended to be applied to a range of meat, and not limited to lamb meat.

### Experiment 5

This experiment was conducted by the Product Development Research Centre at Otago University.

Overview: Four cuts of lamb subjected to the example process were assessed in a long-term storage trial undertaken in a commercial refrigeration unit, using an example antimicrobial packaging system. The appearance, odor, total microbial count, and lactic acid bacteria numbers were assessed periodically at five time points over 273 days of storage. All meat samples presented with good color upon opening, with the exception of an untreated loin cut on day 117, which had a plastic-like appearance.

The two boneless cuts (loin and fillet) were free of spoilage-associated odors for the duration of trial. However, two cuts containing bones (leg and rack samples) exhibited an odor change when total microbial numbers exceeded 6.0 log CFU/cm2. During storage up to 273 days, at no point in the trial did total bacteria numbers exceed 8.0 log CFU/cm2, nor did lactic acid bacteria exceed 9.0 log CFU/cm2 for any of the vacuum-packaged and refrigerated lamb cuts. Thus, the storage time possible when using the example process described herein is substantially longer than conventionally achieved with vacuum-packaged and refrigerated lamb. Overall, no systematic increase in microbial numbers was observed.

As lamb ages, the number of bacteria increases with the rate of increase being a function of the bacterial species present, their initial number present at packaging, the storage temperature, and the atmosphere surrounding the meat. The end of shelf life is typically indicated by an aerobic plate count (APC) of greater than 8.0 log CFU/cm2, as a proxy for total bacterial numbers and lactic acid bacteria numbers greater than 9.0 log CFU/cm2.

A treatment using a chemical generally regarded as safe by the FDA (USA) has been used in a number of experiments to extend the shelf life of foods. In this series of experiments, the influence of the active chemical on the shelf life of vacuum packaged chilled lamb was investigated.

### Example Processing

All cuts of meat were derived from lamb carcasses slaughtered at South Pacific Meats (SPM), Awarua. The lambs were slaughtered according to New Zealand regulations, cuts were collected and packaged following SPM processing and hygiene procedures, and the carcass grade was eligible for export to the UK, for example. The meat was refrigerated after slaughter and packaged the next day.

The four cuts of meat used in the shelf-life trial were leg, rack, loin and fillet (striploin). The samples were packaged according to the example process, including packaging in polymer bags and sealed under vacuum. Temperatures of the cuts being processed at time of packing was between 1.9° C. and 2.0° C. After sealing, the meat was packaged into five cartons containing one sample of each cut of meat. All cartons were, identified, sealed and stored on a frame in the SPM EQ refrigeration unit (controlled temperature).

At time zero total microbial numbers and lactic acid bacteria numbers were determined for four samples from each of the four cuts.

At each of day 117, day 160, day 188, day 250 and day 273, one carton was removed from the refrigeration unit and transported to Dunedin under chilled storage for evaluation.

### Example Evaluation

Assessment of appearance and odor was informally assessed by the Product Development Research Center.

Microbial Analyses

Wet and dry swab kits were supplied by Gribbles LabNet (Mosgiel) for total aerobic plate count (APC) and lactic acid bacteria sample collection. Bags containing the meat cuts were opened aseptically, the swab template placed on the meat surface and swabbed. For day 117, day 160, day 250 and day 273, swabbing of the meat was carried out at the University of Otago, while for day 188 sampling and counting was carried out by Watercare, Invercargill (due to Covid-19 lockdown). Watercare also supplied photographs and comments on the color and odor of the meat cuts on opening the packages. From the start (day 0) to day 188, one swab per cut was taken. Due to some abnormal results from the day 188 counts, two swabs for total microbial numbers were taken for the day 250 and day 273 samples to improve the reliability of the microbial numbers obtained. Total microbial numbers were determined by Total Plate Count, as per MIMM6 method carried out by Gribbles Labnet. Lactic acid bacteria numbers were determined as per MIMM9 method Eurofins ELS Ltd (via Gribbles Labnet).

### Example Results

Visual and odor assessments: the color of the meat cuts was generally good until at least day 160 and improved further after opening the bags as the meat bloomed (see Table 1). At day 250 and day 273, the meat cuts containing bone appeared to have a slight green tinge to the silverskin or fat. This color rapidly disappeared upon exposure of the sample to air. At day 117, the control loin possessed a plastic-like texture, although it is thought that this was due to an abnormally high pH (6.33).

TABLE 1
Visual appearance of control and processed
lamb cuts: day 117-day 273

| Day | Leg | Rack | Loin | Fillet |
|---|---|---|---|---|
| 117 | Color good | Color good | Color good¹ | Color good |
| 160 | Color good | Color good | Color good | Color good |
| 188³ | “Good” | “Good” | “Good” | “Good” |
| 250 | Green² | Green² | Color good | Color good |
| 273 | Green² | Green² | Color good | Color good |

¹Loin at Day 117, which appeared pale and plastic looking - the texture of this sample was very firm.
²Any green color noted in products was detected on the silverskin or fat of the meat, and along the seals of the plastic packaging. Color returned to normal after opening and exposure to air.
³“Good” - Photographs supplied by Watercare showed the meat samples to all be of good color.

The odor of the loin and fillet were “normal” and “meat-like” though tending towards “old” by the end of the trial. The odors of the leg and rack samples were more changeable. Some spoilage odors were noted in the rack at day 117 and again from day 250. In the leg samples, a change in odor was observed from day 250. There was no trend with respect to any changes in odors. The odor change in the bone-containing meat samples were described as “old meat.” One odd odor was described as a faint bleach/chemical odor for a treated rack at day 117.

TABLE 2
Odor of the control and processed lamb cuts: day 117-day 273

| Day | Leg | Rack | Loin | Fillet |
|---|---|---|---|---|
| 117 | Good | Slight bleach | Good | Good |
| 160 | Good | Good | Good | Good |
| 188¹ | “Good” | “Good” | “Good” | “Good” |
| 250 | Strong odor, | Strong odor, | Good | Good |
| | old blood, | sour, cheese, | | |
| | odor remains | odor remains | | |
| | 24 h after | 24 h after | | |
| | opening. | opening. | | |
| 273 | Strong odor | Strong odor, | Good | Good |
| | sour, old | sour, off meat, | | |
| | blood, odor | odor remains | | |
| | remains 24 h | 24 h after | | |
| | after opening | opening. | | |

¹Due to the Covid-19 level 4 lockdown, the meat samples were assessed by Watercare. The meat samples had an acceptable odor on opening the samples for analysis on day 188.

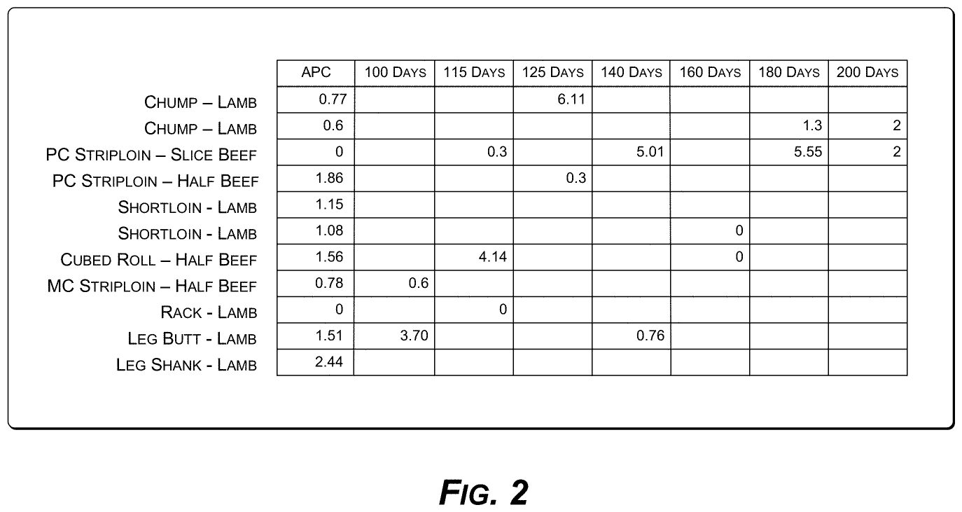

Total microbial numbers ranged from less than 0.3 to 7.54 log CFU/cm2 (see Table 3; and FIG. 2). However, the pattern of change was not systematic.

When comparing the total microbial numbers to the odor descriptions, it was observed that at the higher numbers (greater than 6.5 log CFU/cm2) the odors started to change and were described as “less fresh” odors.

TABLE 3
Total microbial numbers (log
CFU/cm²)¹ of processed cuts: day 117-day 273

| Day | Leg | Fillet | Loin | Rack |
|---|---|---|---|---|
| 117 | 5.48 | 5.41 | 2.04 | 5.72 |
| 160 | 6.68 | 3.92 | 1.78 | 7.54 |
| 188² | 4.56 | 1.73 | <0.3 | >3.70 |
| 250 | 6.41 | 5.33 | <1.04 | 6.41 |
| 273 | 6.00 | 6.41 | 3.52 | 6.78 |

¹measured as Total Aerobic Plate Counts (APCs) and expressed as log10 cfu/cm²).
²Microbial assessment of all samples was at Watercare due to Covid-19 and the corresponding level 4 lockdown.

In FIG. 2, the initial numbers of bacteria were estimated by counting four of each type of lamb cut (leg, rack, loin and fillet). The average initial numbers were similar between each lamb cut, as in Table 4.

TABLE 4
Initial total microbial count (log
CFU/cm²)¹ on four replicate lamb cuts

| | Leg | Rack | Fillet | Loin |
|---|---|---|---|---|
| Rep 1 | 1.70 | 0.60 | 1.88 | 1.91 |
| Rep2 | 1.85 | 0.30 | 2.23 | 0.30 |
| Rep3 | 1.87 | 2.65 | 1.15 | 3.24 |
| Rep4 | 2.81 | 2.82 | 1.51 | 1.41 |
| Average | 2.06 | 1.59 | 1.69 | 1.72 |

The results show an interesting feature of considerable variation within the replicates, for example, the total microbial numbers ranged from 2-1738 CFU/cm² (0.30-3.24 log CFU/cm²). Variation in the initial microbial numbers on the cuts was the likely reason for this lack of trend observed in the total microbial numbers during storage. This may make it difficult to draw conclusions about the efficacy of the example process as based on an understanding that the example process may slow growth of bacteria but not completely prevent growth. Multiple samples were used for each sampling point per treatment. Regardless of the variability, the total microbial numbers did not exceed 8.0 log CFU/cm² at any point during the storage trial.

Minimal numbers of lactic acid bacteria were found in all samples at all time points (see Table 5). The maximum number of lactic acid bacteria detected was 3.12 log CFU/cm² in the control leg cut, at day 160. This may be noteworthy, because in conventionally aged, refrigerated vacuum-packaged lamb, lactic acid bacteria are the dominant bacteria.

TABLE 5
Lactic acid bacteria count (log CFU/cm²) of control
and processed lamb cuts: day 117-day 273

| | Leg | Fillet | Loin | Rack |
|---|---|---|---|---|
| Day | treated | treated | treated | treated |
| 117 | 2.76 | <1.30 | 2.40 | <1.30 |
| 160 | 3.09 | <1.30 | <1.30 | 2.56 |
| 188¹ | Not run | Not run | Not run | Not run |
| 250 | <1.30 | <1.30 | <1.30 | 140 |
| 273 | <1.30 | <1.30 | <1.30 | <1.30 |

¹Microbial assessment of all samples was at Watercare due to Covid-19 and the corresponding level 4 lockdown.

Conclusions from the Example Experimental Trial
During storage up to 273 days, at no point in the experimental trial of the example process did total bacteria numbers exceed 8.0 log CFU/cm², nor did lactic acid bacteria exceed 9.0 log CFU/cm² for any of the vacuum packaged, refrigerated lamb cuts. This storage time is substantially longer than conventionally achieved with vacuum-packed chilled refrigerated lamb.
No systematic increase in microbial numbers was found.
Low lactic acid bacteria numbers were found in the lamb cuts at the end of their shelf life.

The conventional recommended shelf life for ovine meats, non-gas flushed, is about 77-84 days. If the meat is gas flushed, the shelf life is about 100 days. The results above clearly demonstrate the usefulness and efficacy of the example process described herein, providing meat that remains fresh well after the standard conventional shelf life.

While the subject matter herein has been exemplified and described with reference to specific examples, the scope extends beyond these specific examples. In particular the subject matter relates to and is useful for extending the shelf life of a range of meats including meats from the ovine, bovine, carpine, and cervine groups.

### Example Method

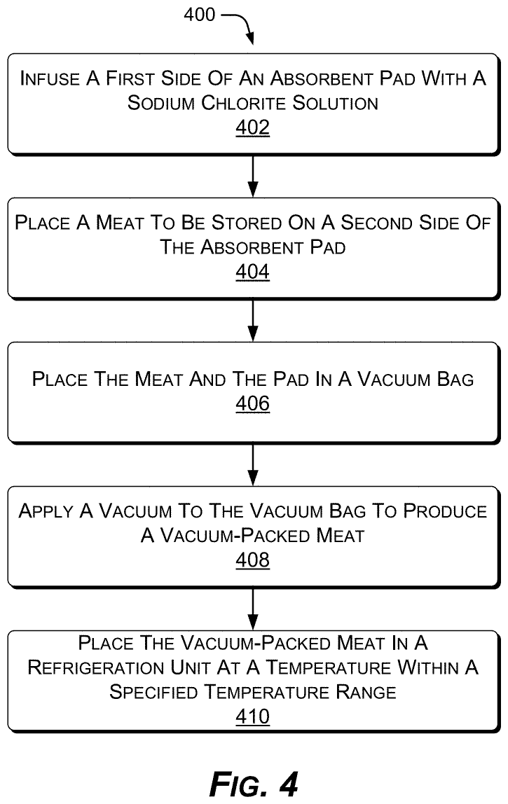

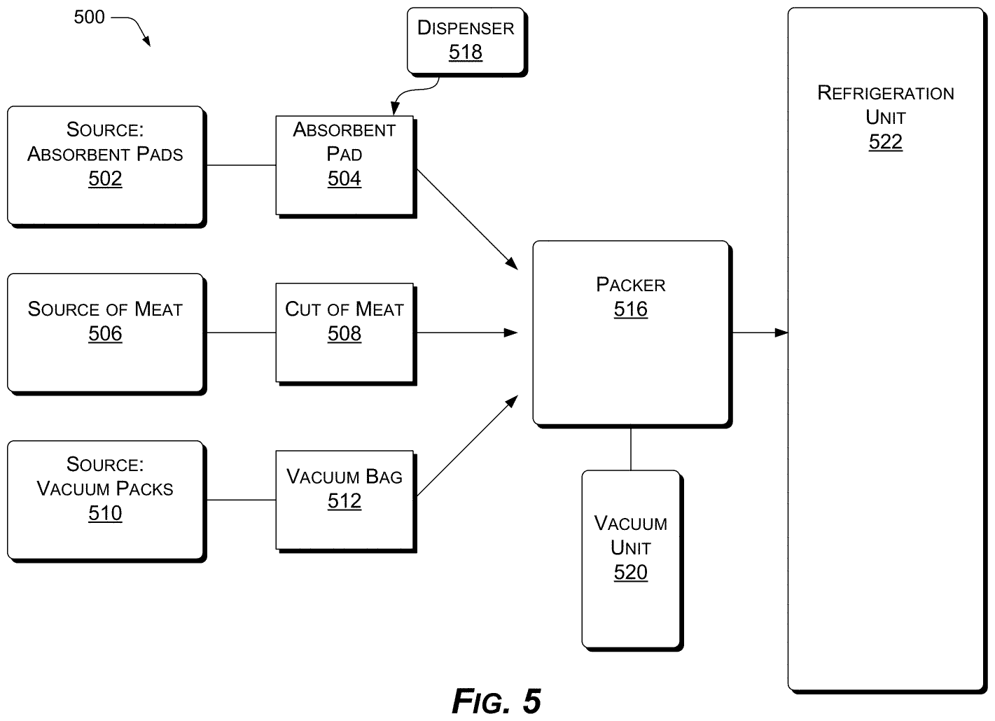

FIG. 4 shows an example method 400 of increasing the storage life of a meat. Operations of the example method 400 are shown as individual blocks in the flow diagram of FIG. 4. The example method 400 may be performed by an apparatus or system, such as the example system of FIG. 5.

At block 402 of the flow diagram in FIG. 4, a first side of an absorbent pad is infused with a sodium chlorite solution.

At block 404, a meat to be stored is placed on a second side of the absorbent pad.

At block 406, the meat and the absorbent pad are placed in a vacuum bag.

At block 408, a vacuum is applied to the vacuum bag to produce a vacuum-packed meat.

At block 410, the vacuum-packed meat is placed in a refrigeration unit at a temperature within a specified temperature range.

In the example method 400, a concentration of chlorite in the sodium chlorite solution may be selected as less than about 100 ppm. For example, the concentration of chlorite in the sodium chlorite solution can be between about 60-100 ppm. In one implementation, the sodium chlorite solution is about 72 ppm.

In the example method 400, the absorbent pad can be between 4-6 inches wide by 6-8 inches long, for example. One embodiment of the absorbent pad can hold between 5-75 grams of the sodium chlorite solution. Another embodiment of the absorbent pad holds between 20-60 grams of the sodium chlorite solution.

In the example method 400, one implementation of the absorbent pad has a first absorbent side, and a second nonabsorbent side. The meat to be stored is placed in contact with the nonabsorbent side, in this example implementation.

In the example method 400, the temperature in the refrigeration unit can be between approximately −1.7 to 0.0 degrees Celsius. The temperature in the refrigeration unit is preferably −1.5 degrees Celsius.

In the example method 400, the meat to be stored can be any meat, such as an ovine meat, a bovine meat, a carpine meat, or a cervine meat, for example.

### Example System

FIG. 5 shows an example system 500 for increasing the storage life of a meat. The example system 500 shown in FIG. 5 is only one implementation of a system with apparatus components for performing the example method, as described herein.

In an implementation, the example system 500 has a first source 502 for providing absorbent pads 504. The first source 502 may be a log roll of absorbent material and cutter for cutting the log roll into absorbent pads of a specified size, such as pads between 4-5 inches wide and 6-8 inches long. The first source 502 may also be a mechanical dispenser for placing the absorbent pads 504 from a stack of the absorbent pads 504 on a conveyor or in each vacuum bag, one at a time.

The example system 500 has a second source 506, providing cuts of a meat 508. The second source 506 may be a conveyor from a refrigerator or refrigerated truck, a butcher operation, a slaughterhouse, and so forth.

The example system 500 has a third source 510, providing vacuum bags 512 for storing the cuts of the meat 508. At least one conveyor 514 transports at least one of the absorbent pads 504, the cuts of the meat 508, or the vacuum bags 512, in an assembly line or packing operation.

The example system 500 has a packer 516 for placing each cut of the meat 508 inside each of the vacuum bags 512 with at least one absorbent pad 504.

A dispenser 518 infuses the sodium chlorite solution into each absorbent pad 504, at some point in the operation of the example system 500, depending on configuration. In one implementation, the dispenser 518 infuses the sodium chlorite solution into each absorbent pad 504 after the absorbent pad 504 has already been placed inside a vacuum bag 512. In another implementation, the dispenser 518 infuses the sodium chlorite solution into each absorbent pad 504 before each absorbent pad 504 is placed into a vacuum bag 512.

A vacuum unit 520 of the example system 500 removes air from each vacuum bag 512 and seals each vacuum bag 512 to provide a vacuum-packed cut of the meat, in the same vacuum bag 512 with the sodium chlorite solution infused in an absorbent pad 504.

A refrigeration unit 522 of the example system 500 maintains each vacuum-packed cut of the meat 508 at a temperature within a specified temperature range, such as between −1.7 to 0.0 degrees Celsius, or preferably at −1.5 degrees Celsius.

In the description above, it is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning, i.e., they will be taken to mean an inclusion of not only the listed components which the use directly references, but also to other non-specified components elements.

In the foregoing specification, specific embodiments have been described. However, one of ordinary skill in the art appreciates that various modifications and changes can be made without departing from the scope of the subject matter as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method for improving a longevity of a stored meat, comprising:
infusing a first side of an absorbent pad with a sodium chlorite solution;
placing a meat to be stored on a second side of the absorbent pad;
placing the meat and the absorbent pad in a vacuum bag;
applying a vacuum to the vacuum bag to produce a vacuum-packed meat; and
placing the vacuum-packed meat in a refrigeration unit at a temperature within a specified temperature range.

2. The method of claim 1, wherein a concentration of chlorite in the sodium chlorite solution comprises less than about 100 ppm.

3. The method of claim 2, wherein the concentration of chlorite in the sodium chlorite solution is between about 60-100 ppm.

4. The method of claim 3, wherein the concentration of chlorite in the sodium chlorite solution is about 72 ppm.

5. The method of claim 1, wherein the absorbent pad comprises 4-6 inches wide by 6-8 inches long.

6. The method of claim 5, wherein the absorbent pad absorbs between 20-60 grams of the sodium chlorite solution.

7. The method of claim 1, wherein the absorbent pad comprises a first absorbent side of the absorbent pad and a second nonabsorbent side of the absorbent pad.

8. The method of claim 1, wherein the absorbent pad comprises a CRYOVAC absorbent meat pad.

9. The method of claim 1, wherein the longevity of the stored meat comprises a refrigerated shelf-life of the stored meat.

10. The method of claim 1, wherein the meat to be stored comprises a fresh meat or a recently slaughtered meat.

11. The method of claim 1, wherein the temperature in the refrigeration unit comprises −1.7 to 0.0 degrees Celsius.

12. The method of claim 11, wherein the temperature in the refrigeration unit comprises −1.5 degrees Celsius.

13. The method of claim 1, wherein the meat to be stored comprises one of an ovine meat, a bovine meat, a carpine meat, or a cervine meat.

14. A system, comprising:
a first source, providing absorbent pads;
a second source, providing cuts of a meat;
a third source, providing vacuum bags for storing the cuts of the meat;
at least one conveyor for transporting at least one of the absorbent pads, the cuts of the meat, or the vacuum bags, in an assembly line;
a packer for placing each cut of the meat inside each of the vacuum bags with at least one absorbent pad;
a dispenser for infusing a sodium chlorite solution into each of the at least one absorbent pad in each vacuum bag;
a vacuum unit for removing air from each vacuum bag and for sealing each vacuum bag to provide a vacuum-packed cut of the meat; and
a refrigeration unit to maintain each of the vacuum-packed cuts of the meat at a temperature within a specified temperature range.

15. The system of claim 14, wherein a concentration of chlorite in the sodium chlorite solution comprises between about 60-100 ppm.

16. The system of claim 15, wherein a concentration of chlorite in the sodium chlorite solution comprises about 72 ppm.

17. The system of claim 14, wherein each absorbent pad is infused with between 5-75 grams of the sodium chlorite solution.

18. The system of claim 14, wherein each absorbent pad comprises a first absorbent side of the absorbent pad and a second nonabsorbent side of the absorbent pad.

19. The system of claim 14, wherein the temperature within the refrigeration unit comprises −1.7 to 0.0 degrees Celsius.

20. The system of claim 19, wherein the temperature within the refrigeration unit comprises −1.5 degrees Celsius.
